(19) United States
(12) Patent Application Publication
(10) Pub. No.: US 2006/0229009 A1
(43) Pub. Date: Oct. 12, 2006

(54) Method for controlling an air circulation part and/or an air supply part in a passenger cell

(76) Inventors: Matthias Illing, Kusterdingen (DE); Michael Arndt, Reutlingen (DE); Gerd Lorenz, Reutlingen (DE); Daniela Winkler, Munich (DE)

Correspondence Address: MICHAEL BEST & FRIEDRICH, LLP, 100 E WISCONSIN AVENUE, MILWAUKEE, WI, 53202, US

(21) Appl. No.: 10/567,485

(22) PCT Filed: Sep. 7, 2003
(86) PCT No.: PCT/DE04/01290

§ 371 Date: Feb. 7, 2006

(30) Foreign Application Priority Data
Aug. 7, 2003 (DE) 103 37 750.6

(51) Int. Cl. B64D 13/00

(52) U.S. Cl. 454/75

(57) ABSTRACT

The invention relates to a method to regulate a circulating air and/or intake air portion (Vₛ, Vₒ) in a passenger compartment of a vehicle, in particular a motor vehicle, with a sensor for detecting hazardous gas concentrations in the passenger compartment and for supplying a triggering signal (1_{CO2}) of a control unit for the circulating air and/or intake air portion (Vₛ, Vₒ) in a passenger compartment. To achieve air supply in a passenger compartment that does justice to demand and is optimized with respect to energy consumption, the sensor for detecting hazardous gas concentrations is a temperature-compensated sensor, whereby the sensor for detecting the ambient temperature along with the sensor for detecting the hazardous gas concentration supply signals (1ₜ, 1_{CO2}) for triggering a control unit for the circulating air and/or intake air portion (Vₛ, Vₒ). The control unit controls either the size of the circulating air portion (Vₛ) in the passenger compartment or switches from complete circulating air operation to complete intake air cooperation and vice versa.

The invention relates to a method to regulate a circulating air and/or intake air portion in a passenger compartment of a vehicle in accordance with the pre-characterizing clause of Claim 1 and a sensor for detecting hazardous gas concentrations in the passenger compartment in accordance with Claim 11.

### PRIOR ART

As much possible constant fresh air should be supplied to the passenger compartment of motor vehicles in order to avoid increased hazardous gas content in the air, particularly increased carbon dioxide content. This prevents the content of carbon dioxide in the air from the respiratory activity of a person in the passenger compartment from increasing excessively beyond a comfort threshold and leading to impairing the concentration and to signs of fatigue in the person. In vehicles it is known to mix circulating air, i.e., air from the interior of the vehicle and intake air, i.e., air from outside the passenger compartment, for the air stream being used for the air conditioning in the passenger compartment. The circulating air and/or intake air portions are heated or cooled in the process with the aid of an air conditioner embodied as a cooling/heating device. Admixing the circulating air with the outside air takes place in vehicles under aspects related to energy as a function of the desired passenger compartment temperature or taking the respective hazardous materials concentration of the outside air in consideration.

DE 199 13 848 A1 describes a method to regulate a circulating air and/or intake air portion in a passenger compartment of a vehicle in which the portion of circulating air in the air stream supplied to the passenger compartment is restricted by means of a CO₂ sensor in such a way that the portion of carbon dioxide in the passenger compartment does not exceed a specific limit value. The CO₂ sensor can detect the CO₂ portion of the air in the passenger compartment and/or the intake air. The output signal of the CO₂ sensor is adjacent to a control unit, which controls the portion of circulating air in the air stream introduced to the passenger compartment.

The known methods for regulating a circulating air and/or intake air portion in a passenger compartment do not operate with minimized energy expenditure. In addition, the measuring precision of the sensors used to detect hazardous gas concentrations in the passenger compartment is a function of many parameters of the environment of the sensor, in particular of the temperature of the surroundings.

### ADVANTAGES OF THE INVENTION

The method in accordance with the invention for regulating a circulating air and/or intake air portion in a passenger compartment of a vehicle with the features cited in Claim 1 and the sensor to execute the method in accordance with Claim 11 offers the advantage that the hazardous gas concentration, in particular the CO₂ concentration in the air of the passenger compartment can be detected quickly and in a precisely reproducible manner. The temperature-compensated sensor for detecting hazardous gas concentrations in the passenger compartment triggers a control unit, e.g., a servomotor with a circulating air flap, with its signals representing the temperature in the passenger compartment and its signals representing the hazardous gas concentration in the passenger compartment. The circulating air flap can be a part of a cooling/heating device, like an air conditioner for instance. In this case, either alternating exclusive operation with intake air or with circulating air for supplying the passenger compartment with air can be represented. It can also be expedient to modify the intake air and circulating air portions in terms of their respective size via the control unit and constitute the air supply of the passenger compartment with intake air and circulating air simultaneously.

If the air supply of the passenger compartment is constituted with alternating operations between exclusively intake air operation and exclusively circulating air operation, then the intake air operation can be executed preferably if a pre-definable first concentration threshold of hazardous gas is exceeded in the passenger compartment. It can be switched to circulating air operation if a second concentration threshold, which is smaller than the first concentration threshold, is fallen short of in the passenger compartment. A comfort threshold of the hazardous gas concentration in the passenger compartment can be maintained in this way.

With mixed operation in the passenger compartment and with circulating air and intake air, a pre-definable range of a hazardous gas concentration can be maintained in the passenger compartment.

The temperature compensation of the sensor for detecting hazardous gas concentrations takes place in accordance with a signal of a temperature sensor for measuring the air temperature in the passenger compartment. The signal of the temperature sensor can also be used to describe the temperature of the intake air and, therefore, the outside temperature of the passenger compartment. In order to minimize the cooling capacity of an air conditioner of the vehicle and, therefore, the fuel consumption of a vehicle, the control unit for the circulating air and/or intake air portion controls the air supply in the passenger compartment on the basis of the signal of the temperature sensor, so that when the temperature increases a switch is made to circulating air operation or the circulating air portion of the air supplied to the passenger compartment is increased.

Because of the method to regulate a circulating air and/or intake-air portion in a passenger compartment, a comfort threshold of the CO₂ concentration in the passenger compartment of 0.2% by volume can be set for example. Thus, a circulating air portion of approx. 80% can be set in a passenger compartment occupied by a person via the control unit for the circulating air and/or intake portion without the usual comfort threshold of the hazardous gas concentration being exceeded.

If the sensor for detecting the hazardous gas is embodied as a CO₂ sensor, it can also be used to monitor leaks in a vehicle air conditioner that operates with carbon dioxide as a refrigerant.

The sensor for detecting the hazardous gas concentration in the passenger compartment communicates with its environment either with an analog or preferably digital LIN interfaces, which permits various operating modes of the sensor. The sensor for detecting hazardous gas concentrations in the passenger compartment measures the hazardous gas concentration in a measuring cuvette in accordance with the principle of photometric gas measurement, whereby the wavelength-specific weakening at 4.2 μm to 4.3 μm wavelength is measured with an infrared radiation source as a function of the hazardous gas concentration in the measuring cuvette.

The sensor for detecting the hazardous gas concentrations, in particular for detecting the CO₂ concentration in the passenger compartment, is preferably embodied as a structural unit with the sensor for temperature measurement of the ambient temperature of the sensor.

Additional advantageous embodiments are yielded from the remaining features cited in the subordinate claims.

### DRAWINGS

The invention is explained in more detail in the following, in an exemplary embodiment on the basis of the associated drawings. The drawings show:

FIG. 1 A flow chart of a design variation of a method to regulate a circulating air and/or intake air portion in a passenger compartment with alternating operation with circulating air or intake air.

FIG. 2 A flow chart of a design variation of a method to regulate a circulating air and/or intake air portion in a passenger compartment with regulation of the size of the circulating air portion.

### DESCRIPTION OF THE EXEMPLARY EMBODIMENTS

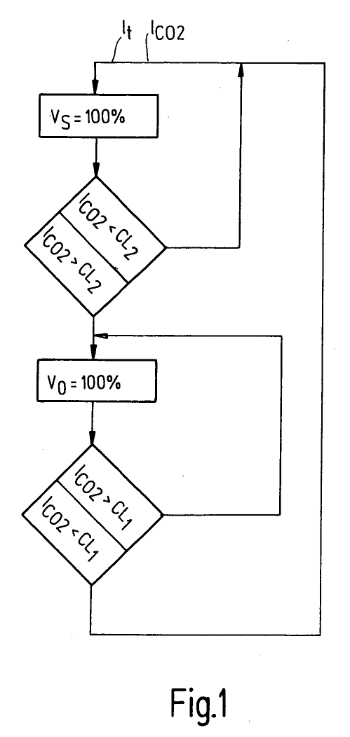

A method to regulate a circulating air and/or intake air portion Vₛ, Vₒ in a passenger compartment of a vehicle is shown in a flow chart in FIG. 1. A fan conveys the air into a passenger compartment, whereby the fan is in a position to remove intake air from outside the passenger compartment as well as circulating air from the interior of the passenger compartment and supply it to the passenger compartment. In the process, a control unit regulates the supply of air to the fan from outside the passenger compartment and/or from the interior of the passenger compartment. A circulating air flap is used for this expediently upstream in front of the fan as a part of the control unit. The fan can be connected downstream or upstream of a heating/cooling device, like those that is used in motor vehicles.

A sensor for detecting hazardous gas concentrations in the passenger compartment, in particular a CO₂ sensor, which is temperature-compensated to stabilize its measuring accuracy, triggers the control unit for the circulating air and/or intake air portion Vₛ, Vₒ in the passenger compartment with its temperature signal 1ₜ and its signal 1_{CO2} that represents the hazardous gas concentration in the passenger compartment. The sensor (not shown) is embodied in the cited exemplary embodiments as a CO₂ sensor in the form of an infrared detector. The sensor operates in a preferred measuring range of 9 g/m³ to 54 g/m³ corresponding to 0.5 to 3% by volume CO₂ and determines the CO₂ concentration in the air of the passenger compartment in accordance with the principle of photometric gas measurement at wavelengths of 4.2 μm and 4.3 μm and with a reference wavelength between 3.8 μm and 4.0 μm.

A sensor for measuring the ambient temperature, of the sensor for detecting the hazardous gas concentration in the passenger compartment is used for temperature compensation of the sensor for detecting the hazardous gas concentration. Both sensors preferably form a structural unit.

As FIG. 1 shows, the control unit for the circulating air and/or intake air portion Vₛ, Vₒ in the passenger compartment, controls the fan as a function of the temperature signal (1ₜ) and the signal (1_{CO2}), which represents the CO₂ concentration of the air in the passenger compartment, in such a way that it is supplied either exclusively circulating air (Vₛ=100%) from the passenger compartment or exclusively intake air (Vₒ=100%) from outside the passenger compartment.

Circulating air operation is then maintained in the process until a hazardous gas concentration threshold value CL₂ that indicates a comfort threshold is exceeded. When the hazardous gas concentration threshold value CL₂ is exceeded, a switch is made to intake air operation (Vₒ=100%) and air is conveyed from outside the passenger compartment into the passenger compartment until a hazardous gas concentration threshold value CL₁ is fallen short of. The hazardous gas concentration threshold value CL₁ is less than the hazardous gas concentration threshold value CL₂.

Because of the cooling/heating device, the temperature in the passenger compartment is kept at a desirable level, whereby the temperature sensor for temperature compensation, as a sensor for detecting the hazardous gas concentration in the passenger compartment, makes available an actual temperature value of the control unit for the circulating air and/or intake air portion Vₛ, Vₒ in the passenger compartment.

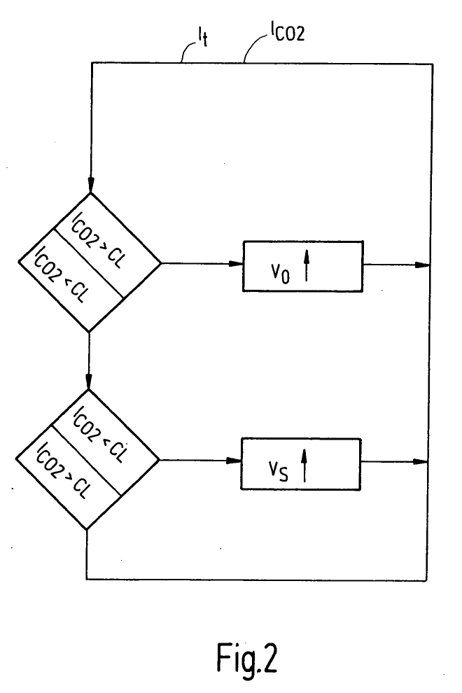

As FIG. 2 shows, instead of fully switching from circulating air operation to intake air operation and vice versa, it can be expedient instead to always constitute a mixed air operation with circulating air and intake air in the passenger compartment of the vehicle. As a function of a pre-definable tolerable hazardous gas concentration threshold value CL for the air in the passenger compartment, the intake air portion is increased when a permissible tolerance concentration of hazardous gas is exceeded, i.e., CO₂ in the exemplary embodiment. If the pre-definable hazardous gas concentration threshold value CL falls short of a permissible tolerance concentration of hazardous gas, then, in order to minimize the energy requirement of the method, the circulating air portion of the air being supplied to the passenger compartment is increased and the intake air portion is reduced. The reduction of the intake air portion can also be meaningful if, because of high outside temperatures of the passenger compartment and an increased temperature of the intake air, the intake air must be cooled with a corresponding expenditure of energy.

The methods to regulate the circulating air and/or intake air portion in a passenger compartment that is depicted in FIGS. 1 and 2 can be represented with a single cooling/heating device in the vehicle.

1. Method to regulate a circulating air and/or intake air portion (Vₛ, Vₒ) in a passenger compartment of a vehicle, in particular a motor vehicle, with a sensor for detecting hazardous gas concentrations in the passenger compartment and for supplying a triggering signal (1_{CO2}) of a control unit for the circulating air and/or intake air portion (Vₛ, Vₒ) in a passenger compartment, characterized in that the sensor is a temperature-compensated sensor, whereby, in addition to the hazardous gas concentration measured by the sensor, the temperature (1ₜ) measured by the sensor for temperature compensation of the sensor for detecting the hazardous gas concentration is used to regulate the circulating air and/or intake air portion (Vₛ, Vₒ) in the passenger compartment.

2. Method according to claim 1, characterized in that the control unit for the circulating air and/or intake air portion (Vₛ, Vₒ) induces the supply of the passenger compartment in an alternating manner with either exclusively circulating air or exclusively intake air as a function of exceeding or falling short of a hazardous gas concentration threshold value (CL).

3. Method according to claim 1, characterized in that the control unit for the circulating air and/or intake air portion controls the size of the circulating air portion (Vₛ) in the passenger compartment of the vehicle.

4. Method according to claim 3, characterized in that the size of the circulating air portion (Vₛ) in the passenger compartment controlled by the control unit moves in a pre-definable range of a tolerable hazardous gas concentration in the passenger compartment.

5. Method according to claim 1, characterized in that the control unit for the circulating air and/or intake air portion (Vₛ, Vₒ) increases the circulating air portion (Vₛ) in the passenger compartment when there is an increase in the outside temperature of the passenger compartment.

6. Method according to claim 1, characterized in that the control unit for the circulating air and/or intake air portion (Vₛ, Vₒ) is a part of a cooling/heating device.

7. Method according to claim 1, characterized in that the sensor for detecting hazardous gas concentrations detects the carbon dioxide concentration in the passenger compartment.

8. Method according to claim 7, characterized in that the hazardous gas concentration threshold value in the passenger compartment is selected at 0.2% by volume CO₂.

9. Method according to claim 1, characterized in that the control unit for the circulating air and/or intake air portion (Vₛ, Vₒ) adjusts the circulating air portion (Vₛ) in the passenger compartment to approx. 80% when a person is located in the passenger compartment.

10. Method according to claim 1, characterized in that the sensor for detecting hazardous gas concentrations communicates with the control unit for the circulating air and/or intake air portion via an analog or a digital interface.

11. Sensor for regulating a circulating air and/or intake air portion (Vₛ, Vₒ) in a passenger compartment of a motor vehicle, the sensor detecting hazardous gas concentrations in the passenger compartment and supplying a triggering signal (1_{CO2}) of a control unit for the circulating air and/or intake air portion (Vₛ, Vₒ) in the passenger compartment, characterized in that the sensor is a temperature-compensated sensor, whereby, in addition to the hazardous gas concentration measured by the sensor, the temperature (1ₜ) measured by the sensor for temperature compensation of the sensor for detecting the hazardous gas concentration is used to regulate the circulating air and/or intake air portion (Vₛ, Vₒ) in the passenger compartment, characterized in that the CO₂ concentration in the passenger compartment is measured by the sensor via a wavelength-specific weakening of electromagnetic radiation in the infrared range.

12. Sensor according to claim 11, characterized in that the carbon dioxide concentration is measured by the sensor at wavelengths between 4.2 μm and 4.3 μm and a reference wavelength between 3.8 μm and 4.0 μm.

13. Sensor according to claim 11, characterized in that the sensor for detecting hazardous gas concentrations in the passenger compartment and the sensor for temperature compensation form a structural unit.

14. Method according to claim 11, characterized in that the control unit for the circulating air and/or intake air portion (Vₛ, Vₒ) induces the supply of the passenger compartment in an alternating manner with either exclusively circulating air or exclusively intake air as a function of exceeding or falling short of a hazardous gas concentration threshold value (CL).

15. Method according to claim 11, characterized in that the control unit for the circulating air and/or intake air portion controls the size of the circulating air portion (Vₛ) in the passenger compartment of the vehicle.

16. Method according to claim 15, characterized in that the size of the circulating air portion (Vₛ) in the passenger compartment controlled by the control unit moves in a pre-definable range of a tolerable hazardous gas concentration in the passenger compartment.

17. Method according to claim 11, characterized in that the control unit for the circulating air and/or intake air portion (Vₛ, Vₒ) increases the circulating air portion (Vₛ) in the passenger compartment when there is an increase in the outside temperature of the passenger compartment.

18. Method according to claim 11, characterized in that the control unit for the circulating air and/or intake air portion (Vₛ, Vₒ) is a part of a cooling/heating device.

19. Method according to claim 11, characterized in that the hazardous gas concentration threshold value in the passenger compartment is selected at 0.2% by volume CO₂.

20. Method according to claim 11, characterized in that the control unit for the circulating air and/or intake air portion (Vₛ, Vₒ) adjusts the circulating air portion (Vₛ) in the passenger compartment to approx. 80% when a person is located in the passenger compartment.
